(19) United States
(12) Patent Application Publication
(10) Pub. No.: US 2026/0352430 A1
(43) Pub. Date: Nov. 5, 2026

(54) Method and Apparatus Used for Wireless Communication

(71) Applicant: Honor Device Co., Ltd., Shenzhen (CN)

(72) Inventor: Xiaobo Zhang, Shenzhen (CN)

(21) Appl. No.: 19/730,046

(22) Filed: Jul. 2, 2026

Related U.S. Application Data
(63) Continuation of application No. PCT/CN2025/070334, filed on Jan. 3, 2025.

(30) Foreign Application Priority Data
Jan. 3, 2024 (CN) 202410012139.1

(51) Int. Cl. H04L 5/00; H04B 7/0456

(52) U.S. Cl. CPC H04L 5/0098; H04B 7/0456

(57) ABSTRACT

In a method and an apparatus used for wireless communication, a first node sends first type capability information, where the first type capability information includes a MIMO-related parameter of a first frequency band; and sends first information, where the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

### CROSS-REFERENCE TO RELATED APPLICATIONS

This is a continuation of International Patent Application No. PCT/CN2025/070334, filed on Jan. 3, 2025, which claims priority to Chinese Patent Application No. 2024100121391, filed on Jan. 3, 2024, both of which are incorporated herein by reference in their entireties.

### TECHNICAL FIELD

This disclosure relates to a method and an apparatus in a wireless communication system, and in particular, to a scheme and an apparatus for an artificial intelligence/machine learning (AI/ML) model in the wireless communication system.

### BACKGROUND

In conventional wireless communication, reporting of a user equipment (UE) may include at least one of various auxiliary information, such as channel state information (CSI), beam management-related assistance information, and positioning-related assistance information. The CSI includes a channel resource indicator (CRI or channel state information reference signal resource indicator (CSI-RS)), a rank indicator (RI), a precoding matrix indicator (PMI), a channel quality indicator (CQI), or the like.

A network device selects a proper transmission parameter for a UE based on the reporting of the UE, for example, a parameter such a camped cell, a modulation and coding scheme (MCI), a transmitted precoding matrix indicator (TPMI), and a transmission configuration indication (TCI). In addition, the reporting of the UE can be used to optimize a network parameter, for example, better cell coverage and turning a base station on and off based on a UE location.

In a cellular system such as long term evolution (LTE) and New Radio (new radio, NR), the network device such as a base station or a core network device sends a capability query command to the UE, and then the UE sends capability information to the network device. The network device respects the received UE capability information when configuring or scheduling the UE. The UE capability information includes frequency band-specific multiple-input multiple-output (MIMO)-related parameters, which include, for example, a beam measurement-related parameter, a reference signal (RS) resource measurement-related parameter, a CSI reporting-related parameter, and a codebook parameter.

With continuous maturity of an AI/ML technology, applying the AI/ML technology to communication becomes a research hotspot. For example, in the NR (release) 18, artificial intelligence (AI) or machine learning (ML)-based CSI compression, beam management, positioning, and another technology are being researched. In 6G communication, the AI/ML is also quite likely to become a research focus.

### SUMMARY

One application of a trainable model such as AI/ML, is to process information from a wireless channel, and this can obtain performance far exceeding a conventional signal processing algorithm in some specific areas. A model such as AI/ML may rely on a conventional signal processing capability to process the information from the wireless channel, to perform functions such as switching between AI/ML and conventional signal processing, AI/ML performance detection, and AI/ML performance calibration. Generation of an AI/ML model requires training on a large amount of data, and a training function may be deployed on a communication device end or on a remote server. An existing UE capability reporting mechanism cannot adequately support capability reporting related to the trainable model such as AI/ML.

In response to the foregoing problem, this disclosure discloses a solution. It should be noted that although a large quantity of embodiments of this disclosure are developed for AI/ML; and in a case of no conflict, these embodiments are also applicable to a scheme based on a conventional scheme such as signal processing-based capability reporting, especially considering that a unified implementation can significantly reduce hardware complexity or save costs. A specific channel processing or reconstruction algorithm is likely to be non-standardized or implemented by a hardware device manufacturer. In a case of no conflict, embodiments of any node and features in the embodiments of this disclosure may be applied to any other node. In a case of no conflict, embodiments and features in the embodiments of this disclosure may be arbitrarily combined with each other.

If necessary, interpretation of terms in this disclosure may refer to descriptions in the 3rd Generation Partner Project (3GPP) specification protocols TS37 series and TS38 series.

This disclosure discloses a method in a first node used for wireless communication, including: sending first type capability information, where the first type capability information includes a MIMO-related parameter of a first frequency band; and sending first information, where the first information includes a first type identifier list, and any first type identifier in the first type identifier list indicates a trainable model.

For the trainable model indicated by at least one first type identifier in the first type identifier list in the first information, whether the trainable model is applied to the first frequency band depends on the MIMO-related parameter on the first frequency band.

In an embodiment, the method associates reporting of the trainable model with a codebook parameter. This reduces reporting signaling overheads and saves an air interface resource.

In an embodiment, the method avoids reporting a first type identifier for each frequency band. This reduces reporting signaling overheads and saves an air interface resource.

In an embodiment, when a trainable model is not applied to the first frequency band, the first node is not configured with the trainable model for the first frequency band.

In an embodiment, when a trainable model is not applied to the first frequency band, it is assumed that the first node is not configured with the trainable model for the first frequency band.

In an embodiment, when a trainable model is not applied to the first frequency band, even if the trainable model is configured for the first frequency band, the first node abandons performing an operation based on the trainable model, for example, calculating and reporting CSI based on the trainable model, and calculating and reporting location assistance information based on the trainable model.

In an embodiment, when a trainable model is not applied to the first frequency band, even if the trainable model is configured for the first frequency band, the first node uses conventional reporting instead of reporting based on the trainable model, and the conventional reporting may be conventional CSI, conventional beam-related reporting information, and the like.

Specifically, according to one aspect of this disclosure, the MIMO-related parameter of the first frequency band includes a codebook parameter. When the codebook parameter of the MIMO-related parameter of the first frequency band does not include a first type codebook, the trainable model indicated by the at least one first type identifier in the first type identifier list is unavailable for the first frequency band; and the first type codebook is non-constant modulus.

Compared with a conventional constant modulus codebook, for example, a codebook based on inverse fast Fourier transform (IFFT), a non-constant modulus codebook can provide higher quantization precision. A frequency band that does not support the first type codebook does not support the trainable model, and this can avoid discontinuity in CSI feedback precision.

Further, the method can avoid calibrating or monitoring performance of the trainable model using a low-precision codebook. This can effectively guarantee the performance of the trainable model.

In an embodiment, the first type codebook is an enhanced second type codebook.

In an embodiment, precision of the first type codebook is not lower than that of the enhanced second type codebook.

In an embodiment, any vector in the first type codebook is obtained through linear superposition of a plurality of vectors.

In an embodiment, each of the plurality of vectors represents a beam direction or a time path.

In an embodiment, each of the plurality of vectors represents a beam direction, a time path, or a Doppler frequency shift.

Specifically, according to one aspect of this disclosure, the MIMO-related parameter of the first frequency band includes a beam measurement-related parameter. When the beam measurement-related parameter of the MIMO-related parameter of the first frequency band does not include measuring a first type RS resource, the trainable model indicated by the at least one first type identifier in the first type identifier list is unavailable for the first frequency band.

The method associates the trainable model with conventional RS resource measurement. This has good compatibility.

In an embodiment, the first type RS resource is a downlink RS resource other than an synchronization signal/physical broadcast channel block (SSB or SS/PBCH block).

The foregoing embodiment helps to ensure the performance of the trainable model.

In an embodiment, the first type RS resource is a CSI-RS resource.

In an embodiment, the first type RS resource is an aperiodic CSI-RS resource.

In an embodiment, the first type RS resource is a CSI-RS resource for measuring Layer 1 reference signal received power (L1-RSRP).

In an embodiment, that the beam measurement-related parameter of the MIMO-related parameter of the first frequency band does not include measuring a first type RS resource refers to: a maximum quantity of first type RS resources, for measurement, indicated by the beam measurement-related parameter of the MIMO-related parameter of the first frequency band is 0.

Specifically, according to one aspect of this disclosure, the first type capability information includes reporting type information. When the reporting type information on the first frequency band does not include first type reporting, the trainable model indicated by the at least one first type identifier in the first type identifier list in the first information is unavailable for the first frequency band; and the first type reporting is used to determine performance of the trainable model.

The method associates the trainable model with conventional CSI reporting. This has good compatibility.

In an embodiment, the first type reporting is obtained based on an algorithm of conventional signal processing.

In an embodiment, the first type reporting indicates raw channel information.

In an embodiment, the first type reporting is aperiodic.

In an embodiment, the first type reporting is aperiodic CSI.

In an embodiment, the first type reporting is an aperiodic PMI.

Specifically, according to one aspect of this disclosure, sending of the first information is triggered by any condition in a first set of conditions.

One condition in the first set of conditions is that at least one first type identifier currently supported by the first node does not belong to a first type identifier list reported most recently, and the first type identifier list in the first information includes the at least one first type identifier currently supported by the first node.

The method enables sending of the first information to be triggered by an update of the first type identifier list. This improves reporting flexibility of the first information.

In an embodiment, the method enables a function corresponding to the first information not necessarily to be deployed inside the first node. This improves deployment flexibility.

Specifically, according to one aspect of this disclosure, it is characterized by including: receiving second information, where the second information requests capability information of the first node.

Sending of the first information is triggered by receiving of the second information.

In an embodiment, one condition in the first set of conditions is receiving of the second information.

In an embodiment, both the second information and the first information are radio resource control (RRC) layer signaling.

In an embodiment, both the second information and the first information are non-access stratum signaling.

In an embodiment, both the second information and the first information are RRC layer signaling, and the second information and the first information are respectively a UECapabilityEnquiry message and a UECapabilityInformation message.

In an embodiment, both the second information and the first information are non-access stratum (NAS) signaling, and the second information and the first information are respectively a RequestCapabilities message and a ProvideCapabilities message.

Specifically, according to one aspect of this disclosure, that one condition in the first set of conditions is that at least one first type identifier currently supported by the first node does not belong to a first type identifier list reported most recently includes at least one of the following: after the first type identifier list reported most recently, an application server of the first node is replaced; and after the first type identifier list reported most recently, the first node receives signaling from the application server, and the signaling from the application server indicates the first type identifier currently supported by the first node.

This disclosure discloses a method in a second node used for wireless communication, including: receiving first type capability information, where the first type capability information includes a MIMO-related parameter of a first frequency band; and receiving first information, where the first information includes a first type identifier list, and any first type identifier in the first type identifier list indicates a trainable model.

For the trainable model indicated by at least one first type identifier in the first type identifier list in the first information, whether the trainable model is applied to the first frequency band depends on the MIMO-related parameter on the first frequency band.

In an embodiment, when a trainable model is not applied to the first frequency band, the second node does not configure the trainable model for a sender of the second information for the first frequency band.

In an embodiment, when a trainable model is not applied to the first frequency band, the second node assumes that a sender of the second information does not perform an operation based on the trainable model for the first frequency band.

In an embodiment, when a trainable model is not applied to the first frequency band, even if the trainable model is configured for the first frequency band, it is assumed that the second node cannot obtain feedback based on the trainable model, such as CSI calculated and reported based on the trainable model, and location assistance information calculated and reported based on the trainable model.

In an embodiment, when a trainable model is not applied to the first frequency band, even if the trainable model is configured for the first frequency band, it is assumed that what is received by the second node is conventional reporting rather than reporting based on the trainable model, and the conventional reporting may be conventional CSI, conventional beam-related reporting information, and the like.

Specifically, according to one aspect of this disclosure, it is characterized by including: a second transmitter configured to send second information, where the second information requests capability information of a first node.

Sending of the first information is triggered by receiving of the second information.

Specifically, according to one aspect of this disclosure, the MIMO-related parameter of the first frequency band includes a codebook parameter. When the codebook parameter of the MIMO-related parameter of the first frequency band does not include a first type codebook, the trainable model indicated by the at least one first type identifier in the first type identifier list is unavailable for the first frequency band; and the first type codebook is non-constant modulus.

Specifically, according to one aspect of this disclosure, the MIMO-related parameter of the first frequency band includes a beam measurement-related parameter. When the beam measurement-related parameter of the MIMO-related parameter of the first frequency band does not include measuring a first type RS resource, the trainable model indicated by the at least one first type identifier in the first type identifier list is unavailable for the first frequency band.

Specifically, according to one aspect of this disclosure, the first type capability information includes reporting type information. When the reporting type information on the first frequency band does not include first type reporting, the trainable model indicated by the at least one first type identifier in the first type identifier list in the first information is unavailable for the first frequency band; and the first type reporting is used to determine performance of the trainable model.

Specifically, according to one aspect of this disclosure, sending of the first information is triggered by any condition in a first set of conditions.

One condition in the first set of conditions is that at least one first type identifier currently supported by the first node does not belong to a first type identifier list reported most recently, and the first type identifier list in the first information includes the at least one first type identifier currently supported by the first node.

Specifically, according to one aspect of this disclosure, that one condition in the first set of conditions is that at least one first type identifier currently supported by the first node does not belong to a first type identifier list reported most recently includes at least one of the following: after the first type identifier list reported most recently, an application server of the first node is replaced; and after the first type identifier list reported most recently, the first node receives signaling from the application server, and the signaling from the application server indicates the first type identifier currently supported by the first node.

This disclosure discloses a first node used for wireless communication, including: a first transmitter configured to: send first type capability information, where the first type capability information includes a MIMO-related parameter of a first frequency band; and send first information, where the first information includes a first type identifier list, and any first type identifier in the first type identifier list indicates a trainable model.

For the trainable model indicated by at least one first type identifier in the first type identifier list in the first information, whether the trainable model is applied to the first frequency band depends on the MIMO-related parameter on the first frequency band.

Specifically, according to one aspect of this disclosure, the first node is characterized by including: a first receiver configured to receive second information, where the second information requests capability information of the first node.

Sending of the first information is triggered by receiving of the second information.

This disclosure discloses a second node used for wireless communication, including: a second receiver configured to: receive first type capability information, where the first type capability information includes a MIMO-related parameter of a first frequency band; and receive first information, where the first information includes a first type identifier list, and any first type identifier in the first type identifier list indicates a trainable model.

For the trainable model indicated by at least one first type identifier in the first type identifier list in the first information, whether the trainable model is applied to the first frequency band depends on the MIMO-related parameter on the first frequency band.

Specifically, according to one aspect of this disclosure, the second node is characterized by including: a second transmitter configured to send second information, where the second information requests capability information of a first node.

Sending of the first information is triggered by receiving of the second information.

### BRIEF DESCRIPTION OF DRAWINGS

Other features, objectives, and advantages of this disclosure become more apparent by reading detailed descriptions of non-limiting embodiments with reference to the following drawings.

FIG. 1 is a flowchart of communication of a first node according to an embodiment of this disclosure;

FIG. 2 is a schematic diagram of a network architecture according to an embodiment of this disclosure;

FIG. 3 is a schematic diagram of an embodiment of radio protocol architectures for a user plane and a control plane according to an embodiment of this disclosure;

FIG. 4 is a schematic diagram of hardware modules of a communication node according to an embodiment of this disclosure;

FIG. 5 is a flowchart of transmission between a first node and a second node according to an embodiment of this disclosure;

FIG. 6 is a schematic diagram of transmission of third information according to an embodiment of this disclosure;

FIG. 7 is a schematic diagram of a plurality of frequency bands according to an embodiment of this disclosure;

FIG. 8 is a flowchart of measurement in a first RS resource according to an embodiment of this disclosure;

FIG. 9 is a schematic diagram of a system of a trainable model according to an embodiment of this disclosure;

FIG. 10 is a flowchart of transmission of first channel information according to an embodiment of this disclosure;

FIG. 11 is a schematic diagram of a first encoder according to an embodiment of this disclosure;

FIG. 12 is a schematic diagram of a first function according to an embodiment of this disclosure.

FIG. 13 is a schematic diagram of a decoding layer group according to an embodiment of this disclosure;

FIG. 14 is a block diagram of a structure of a processing apparatus in a first node according to an embodiment of this disclosure; and

FIG. 15 is a block diagram of a structure of a processing apparatus in a second node according to an embodiment of this disclosure.

### DESCRIPTION OF EMBODIMENTS

The technical solutions of this disclosure are further described in detail below with reference to the accompanying drawings. It should be noted that, in a case of no conflict, embodiments and features in the embodiments of this disclosure can be arbitrarily combined with each other.

### Embodiment 1

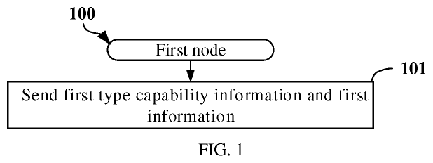

Embodiment 1 illustrates a flowchart of communication of a first node according to an embodiment of this disclosure, as shown in FIG. 1.

The first node 100 sends first type capability information and first information in step 101.

In Embodiment 1, the first type capability information includes a MIMO-related parameter of a first frequency band; the first information includes a first type identifier list, and any first type identifier in the first type identifier list indicates a trainable model; and for the trainable model indicated by at least one first type identifier in the first type identifier list in the first information, whether the trainable model is applied to the first frequency band depends on the MIMO-related parameter on the first frequency band.

In an embodiment, the first type capability information is an RRC layer message.

In an embodiment, the first type capability information includes part or all of fields in a UECapabilityInformation message.

In an embodiment, the first type capability information includes part or all of fields in a UE-NR-Capability message.

In an embodiment, the first type capability information is an rf-Parameters Information Element (information element, IE).

In an embodiment, the first type capability information is a BandNR IE.

In a sub-embodiment of the foregoing embodiment, the first information does not belong to the BandNR IE.

In an embodiment, the first type capability information includes a plurality of pieces of sub-capability information, where the plurality of pieces of sub-capability information are respectively for a plurality of frequency bands, and the first frequency band is any one of the plurality of frequency bands.

In an embodiment, the MIMO-related parameter is configured per band or is specific for a certain band.

In a sub-embodiment of the foregoing embodiment, the first information is not configured per band.

In a sub-embodiment of the foregoing embodiment, the first information is configured per UE.

In a sub-embodiment of the foregoing embodiment, the first information is configured per radio access technology (RAT).

In an embodiment, the MIMO-related parameter includes part or all of fields in MIMO-ParametersPerBand.

In an embodiment, the MIMO-related parameter includes a codebook parameter.

In an embodiment, the MIMO-related parameter includes a beam measurement-related parameter, for example, a maximum quantity of RS resources (SSB or CSI-RS) for L1-RSRP, a maximum quantity of CSI-RS resources for L1-RSRP, a recommended quantity of repetitions of CSI-RS resources per resource set, or CSI-RS density for L1-RSRP.

In an embodiment, when the CSI-RS density for L1-RSRP of the MIMO-related parameter of the first frequency band is less than a first threshold, the trainable model indicated by the at least one first type identifier in the first type identifier list is unavailable for the first frequency band.

In an embodiment, when the recommended quantity of repetitions of CSI-RS resources per resource set of the MIMO-related parameter of the first frequency band is less than a second threshold, the trainable model indicated by the at least one first type identifier in the first type identifier list is unavailable for the first frequency band.

The foregoing two embodiments can satisfy a measurement precision requirement for the trainable model.

In an embodiment, the first threshold is greater than three resource elements (REs) per physical resource block (PRB).

In an embodiment, the first threshold does not exceed 12 REs per PRB.

In an embodiment, the second threshold is not less than 2.

In an embodiment, the second threshold is not greater than 256.

In an embodiment, the MIMO-related parameter includes a CSI measurement-related parameter, for example, a maximum quantity of RS resources (SSB or CSI-RS) for CSI feedback, a maximum quantity of CSI-RS resources for CSI feedback, and maximum CSI-Interference Measurement (IM) density for CSI feedback.

In an embodiment, the trainable model is an AI model.

In an embodiment, the trainable model is an ML model.

In an embodiment, the trainable model is a non-linear model.

In an embodiment, the trainable model is jointly known by a UE and a network device.

In an embodiment, the trainable model is maintained separately by the UE and the network device.

In an embodiment, the first information is a non-access stratum (NAS) message, and the first information is sent to a location service center.

In an embodiment, the first information is an access stratum (AS) message, and the first information is sent to a base station.

In an embodiment, the first node is in an RRC connected state.

In an embodiment, any first type identifier in the first type identifier list is a non-negative integer.

In an embodiment, that any first type identifier in the first type identifier list indicates a trainable model includes: any first type identifier in the first type identifier list indicates a set of parameters, and the set of parameters is used to generate a trainable model.

In an embodiment, the set of parameters is obtained after training.

A person skilled in the art should know that for different types of AI/ML models, content included in the set of parameters may be different. For example, for a convolutional neural network (CNN), the set of parameters may include a threshold of an activation function, a size of a convolution kernel, a step size of the convolution kernel, a weight between feature maps, and the like.

In an embodiment, that any first type identifier in the first type identifier list indicates a trainable model includes: any first type identifier in the first type identifier list indicates a set of parameters, and the set of parameters is used to indicate an applicable scenario of a trainable model.

In an embodiment, that any first type identifier in the first type identifier list indicates a trainable model includes: any first type identifier in the first type identifier list is used to index a trainable model.

In a sub-embodiment of the foregoing embodiment, the trainable model is maintained separately on a first node side and a network device side, and the trainable model maintained by the first node is not the same as the trainable model on the network device side.

In an embodiment, that any first type identifier in the first type identifier list indicates a trainable model includes: any first type identifier in the first type identifier list indicates an executable file, and the executable file is used to generate a trainable model.

In an embodiment, the first type identifier list in the first information includes all first type identifiers currently supported by the first node.

In an embodiment, the first information indicates a physical layer capability.

In an embodiment, the first information belongs to Phy-Parameters.

In an embodiment, the first information belongs to supportedBandListNR.

In an embodiment, the first information indicates a radio frequency capability.

In an embodiment, the first information belongs to RF-Parameters.

In an embodiment, the first type capability information and the first information belong to a same RRC message.

In an embodiment, the first type capability information and the first information belong to a same UECapabilityInformation message.

In an embodiment, the first type capability information and the first information belong to a same UE-NR-Capability message.

In an embodiment, the first type capability information and the first information belong to a same rf-Parameters IE.

In an embodiment, the first type capability information and the first information are both sent through a physical uplink shared channel (PUSCH).

In an embodiment, the first type capability information and the first information are both transmitted through a uplink shared channel (UL-SCH).

In an embodiment, the first type capability information is an RRC message, and the first information is a NAS message.

In a sub-embodiment of the foregoing embodiment, the first information is sent to a location management function (LMF).

### Embodiment 2

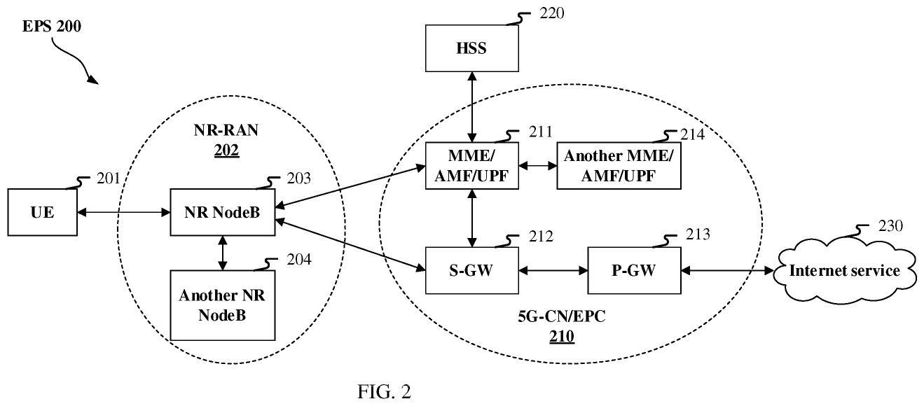

Embodiment 2 illustrates a schematic diagram of a network architecture according to an embodiment of this disclosure, as shown in FIG. 2. FIG. 2 describes the system architecture of 5G new radio (NR), long-term evolution (LTE), and long-term evolution advanced (LTE-A). The 5G NR or LTE network architecture 200 may be referred to as 5G System)/evolved packet system (5GS/EPS) or some other suitable term. The EPS 200 may include a user equipment (UE) 201, an next generation radio access network (NG-RAN) 202, an evolved packet core/5G-core network (5G-CN/EPC) 210, a home subscriber server (HSS) 220, and an internet service 230. The EPS may be interconnected with another access network, but these entities/interfaces are not shown for simplicity. As shown in the figure, the EPS provides a packet switching service; however, a person skilled in the art will readily understand that the various concepts presented throughout this disclosure can be extended to a network providing a circuit switching service or another cellular network. An NG-RAN includes an NR NodeB (gNB) 203 and another gNB 204. The gNB 203 provides user and control plane protocol termination towards the UE 201. The gNB 203 may be connected to the another gNB 204 through an Xn interface (for example, backhaul). The gNB 203 may also be referred to as a base station, a base transceiver station, a radio base station, a radio transceiver, a transceiver function, a basic service set (BSS), an extended service set (ESS), a TRP, or some other suitable term. The gNB 203 provides an access point to the EPC/5G-CN 210 for the UE 201. Instances of the UE 201 include a cellular phone, a smart phone, a session initiation protocol (SIP) phone, a laptop computer, a personal digital assistant (PDA), satellite radio, non-terrestrial base station communication, satellite mobile communication, a global positioning system, a multimedia apparatus, a video apparatus, a digital audio player (for example, an MP3 player), a camera, a game console, a drone, a flying machine, a narrowband internet of things device, a machine type communication device, a land vehicle, an automobile, a wearable device, or any other similar functional apparatus. A person skilled in the art may also refer to the UE 201 as a mobile station, a subscriber station, a mobile unit, a subscriber unit, a wireless unit, a remote unit, a mobile apparatus, a wireless apparatus, a wireless communication apparatus, a remote apparatus, a mobile subscriber station, an access terminal, a mobile terminal, a wireless terminal, a remote terminal, a handset, a user agent, a mobile client, a client, or some other suitable term. The gNB 203 is connected to the EPC/5G-CN 210 through an S1/NG interface. The EPC/5G-CN 210 includes a mobility management entity/authentication management field/user plane function (MME/AMF/UPF) 211, another MME/AMF/UPF 214, a service gateway (S-GW) 212, and a packet data network gateway (P-GW) 213. The MME/AMF/UPF 211 is a control node that processes signaling between the UE 201 and the EPC/5G-CN 210. Generally, the MME/AMF/UPF 211 provides bearer and connection management. All user internet protocol (IP) packets are transmitted through the S-GW 212, and the S-GW 212 itself is connected to the P-GW 213. The P-GW 213 provides UE IP address allocation and another function. The P-GW 213 is connected to the internet service 230. The internet service 230 includes an operator-corresponding internet protocol service, which may specifically include an internet, an intranet, an IP multimedia subsystem (IMS), and a packet switching streaming service.

In an embodiment, the UE 201 corresponds to the first node in this disclosure, and the gNB 203 corresponds to the second node in this disclosure.

In an embodiment, the UE 201 supports generating reporting using artificial intelligence (AI) or machine learning (ML).

In an embodiment, the UE 201, combined with an application server on a UE side, supports generating reporting using AI or ML.

In a sub-embodiment of the foregoing two embodiments, the reporting is used for purposes such as channel information feedback, beam management, or positioning.

In an embodiment, the UE 201 supports generating a trained model using training data or generating part of parameters in a trained model using trained data.

In an embodiment, the UE 201 supports determining at least part of parameters of a convolutional neural network (CNN) for CSI reconstruction through training.

In an embodiment, the UE 201 supports determining a transformer for CSI reconstruction through training.

In an embodiment, the UE 201 is a terminal that supports Massive-MIMO.

In an embodiment, the gNB 203 supports transmission based on Massive-MIMO.

In an embodiment, the gNB 203 supports decompressing CSI using AI or deep learning.

In an embodiment, the gNB 203 supports mobility prediction using AI or deep learning, for example, predicting a beam that the UE 201 is about to enter.

In an embodiment, the gNB 203 is a macro cellular base station.

In an embodiment, the gNB 203 is a micro cell base station.

In an embodiment, the gNB 203 is a picocell base station.

In an embodiment, the gNB 203 is a femtocell.

In an embodiment, the gNB 203 is a base station device that supports large delay spread.

In an embodiment, the gNB 203 is a flying platform device.

In an embodiment, the gNB 203 is a satellite device.

In an embodiment, the first node and the second node in this disclosure are respectively the UE 201 and the gNB 203.

In an embodiment, the second node in this disclosure includes the gNB 203 and a core network function.

In an embodiment, the core network function is an LMF.

In an embodiment, the core network function is used to manage an AI/ML model.

In an embodiment, the core network function is connected to the UE 201 through an AMF.

### Embodiment 3

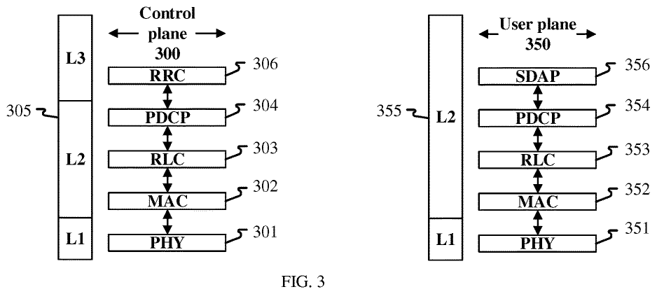

Embodiment 3 illustrates a schematic diagram of an embodiment of radio protocol architectures for a user plane and a control plane according to this disclosure, as shown in FIG. 3. FIG. 3 is a schematic diagram describing the embodiment of the radio protocol architectures for the user plane 350 and the control plane 300, and FIG. 3 shows, with three layers of a layer 1, a layer 2, and a layer 3, a radio protocol architecture for the control plane 300 between a first node device (a UE or a RSU in V2X, or a vehicle-mounted device or a vehicle-mounted communication module) and a second node device (a gNB, a UE or a RSU in V2X, or a vehicle-mounted device or a vehicle-mounted communication module), or between two UEs. The layer 1 (L1 layer) is a lowest layer and implements various physical layer (PHY) signal processing functions. The L1 layer is referred to as a PHY 301 in this specification. A layer 2 (L2 layer) 305 is above the PHY 301 and is responsible for a link between the first node device and the second node device and between the two UEs through the PHY 301. The L2 layer 305 includes a Medium Access Control (medium access control, MAC) sublayer 302, a radio link control (RLC) protocol sublayer 303, and a packet data convergence protocol (PDCP) sublayer 304. These sublayers terminate at the second node device. The PDCP sublayer 304 provides data encryption and integrity protection, and the PDCP sublayer 304 also provides inter-cell mobility support from the first node device to the second node device. The RLC sublayer 303 provides segmentation and reassembly of a data packet, retransmission of a lost data packet through an ARQ, and the RLC sublayer 303 also provides duplicate data packet detection and protocol error detection. The MAC sublayer 302 provides mapping between a logical channel and a transmission channel and multiplexing of the logical channel. The MAC sublayer 302 is also responsible for allocating various radio resources (for example, resource blocks) in a cell among first node devices. The MAC sublayer 302 is also responsible for a HARQ operation. A radio resource control (RRC) sublayer 306 at the layer 3 (L3 layer) in the control plane 300 is responsible for obtaining a radio resource (namely, a radio bearer) and configuring a lower layer using RRC signaling between a second node device and a first node device. A radio protocol architecture for the user plane 350 includes a layer 1 (L1 layer) and a layer 2 (L2 layer). In the user plane 350, the radio protocol architecture for the first node device and the second node device is substantially the same as corresponding layers and sublayers in the control plane 300 for a physical layer 351, a PDCP sublayer 354 at an L2 layer 355, an RLC sublayer 353 at the L2 layer 355, and a MAC sublayer 352 at the L2 layer 355, but the PDCP sublayer 354 also provides header compression for an upper layer data packet to reduce radio transmission overheads. The L2 layer 355 in the user plane 350 also includes a Service Data Adaptation Protocol (service data adaptation protocol, SDAP) sublayer 356, and the SDAP sublayer 356 is responsible for mapping between a QoS flow and a data radio bearer (DRB) to support service diversity. Although not shown in the figure, the first node device may have several upper layers above the L2 layer 355, including a network layer (for example, an IP layer) terminated at a P-GW on a network side and an application layer terminated at the other end of connection (for example, a remote UE and a server).

In an embodiment, the radio protocol architecture in FIG. 3 is applicable to the first node in this disclosure.

In an embodiment, the radio protocol architecture in FIG. 3 is applicable to the second node in this disclosure.

In an embodiment, a reference signal transmitted in an RS resource in this disclosure is generated at the PHY 301.

In an embodiment, CSI in this disclosure is generated at the PHY 301.

In an embodiment, the first type capability information in this disclosure is generated at the RRC sublayer 306.

In a sub-embodiment of the foregoing embodiment, the first information in this disclosure is generated at the RRC sublayer 306.

In a sub-embodiment of the foregoing embodiment, both the first information and the second information in this disclosure are generated at the RRC sublayer 306.

In a sub-embodiment of the foregoing embodiment, the first information in this disclosure is generated at the MAC sublayer 302.

The foregoing sub-embodiments can achieve fast UE capability reporting. This is more suitable for variable UE capabilities.

### Embodiment 4

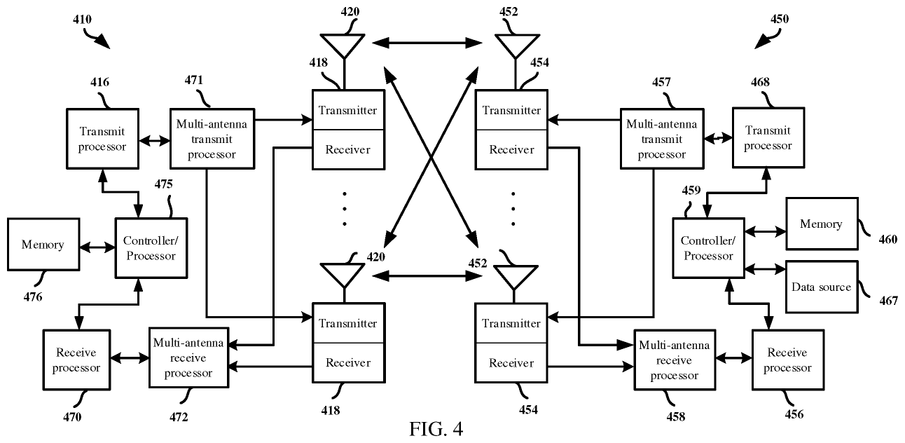

Embodiment 4 illustrates a schematic diagram of hardware modules of a communication node according to an embodiment of this disclosure, as shown in FIG. 4. FIG. 4 is a block diagram of a first communication device 450 and a second communication device 410 communicating with each other in an access network.

The first communication device 450 includes a controller/processor 459, a memory 460, a data source 467, a transmit processor 468, a receive processor 456, a multi-antenna transmit processor 457, a multi-antenna receive processor 458, a transmitter/receiver 454, and an antenna 452.

The second communication device 410 includes a controller/processor 475, a memory 476, a receive processor 470, a transmit processor 416, a multi-antenna receive processor 472, a multi-antenna transmit processor 471, a transmitter/receiver 418, and an antenna 420.

During transmission from the second communication device 410 to the first communication device 450, at the second communication device 410, an upper layer data packet from a core network is provided for the controller/processor 475. The controller/processor 475 implements a function of an L2 layer. During transmission from the second communication device 410 to the first communication device 450, the controller/processor 475 provides header compression, encryption, packet segmentation and reordering, multiplexing between a logical channel and a transport channel, and allocation of radio resources of the first communication device 450 based on various priority metrics. The controller/processor 475 is further responsible for retransmission of a lost packet, and signaling to the first communication device 450. The transmit processor 416 and the multi-antenna transmit processor 471 implement various signal processing functions of an L1 layer (namely, a physical layer). The transmit processor 416 implements channel encoding and interleaving to facilitate forward error correction (FEC) at the second communication device 410, and mapping of signal clusters based on various modulation schemes (such as binary phase shift keying (BPSK), quadrature phase shift keying (QPSK), M-ary phase shift keying (M-PSK), and M-ary quadrature amplitude modulation (M-QAM)). The multi-antenna transmit processor 471 performs digital space precoding, including codebook-based precoding and non-codebook-based precoding, on an encoded and modulated symbol, and beamforming processing, to generate one or more spatial streams. The transmit processor 416 then maps each spatial stream to a subcarrier, multiplexes the mapped spatial stream with a reference signal (for example, a pilot) in time domain and/or frequency domain, and then uses inverse fast Fourier transform (IFFT) to generate a physical channel that carries a time-domain multicarrier symbol stream. Subsequently, the multi-antenna transmit processor 471 performs an operation of analog precoding sending/beamforming on the time-domain multicarrier symbol stream. Each transmitter 418 converts a baseband multicarrier symbol stream provided by the multi-antenna transmit processor 471 into a radio frequency stream, and then provides the radio frequency stream for different antennas 420.

During transmission from the second communication device 410 to the first communication device 450, at the first communication device 450, each receiver 454 receives a signal through a corresponding antenna 452 of the receiver 454. Each receiver 454 recovers information modulated onto a radio frequency carrier, converts a radio frequency stream into a baseband multicarrier symbol stream, and provides the baseband multicarrier symbol stream for the receive processor 456. The receive processor 456 and the multi-antenna receive processor 458 implement various signal processing functions of the L1 layer. The multi-antenna receive processor 458 performs an operation of analog precoding receiving/beamforming on the baseband multicarrier symbol stream from the receiver 454. The receive processor 456 converts, from time domain to frequency domain via fast Fourier transform (FFT), the baseband multicarrier symbol stream obtained after the operation of analog precoding receiving/beamforming. In frequency domain, a physical-layer data signal and a reference signal are demultiplexed by the receive processor 456. The reference signal is used for channel estimation; and the data signal is recovered after multi-antenna detection performed by the multi-antenna receive processor 458, to obtain any spatial stream that uses the first communication device 450 as a destination. A symbol on each spatial stream is demodulated and recovered in the receive processor 456, and a soft decision is generated. The receive processor 456 then performs channel decoding and de-interleaving on the soft decision to recover upper layer data and a control signal transmitted by the second communication device 410 on a physical channel. The upper layer data and the control signal are then provided for the controller/processor 459. The controller/processor 459 implements the function of the L2 layer. The controller/processor 459 may be associated with the memory 460 that stores program code and data. The memory 460 may be referred to as a computer-readable medium. During transmission from the second communication device 410 to the first communication device 450, the controller/processor 459 provides demultiplexing between a transport channel and a logical channel, packet reassembly, decryption, header decompression, and control signal processing, to recover the upper layer data packet from the core network. The upper layer data packet is then provided for all protocol layers above the L2 layer, or various control signals may be provided for an L3 for processing by the L3.

During transmission from the first communication device 450 to the second communication device 410, at the first communication device 450, an upper layer data packet is provided for the controller/processor 459 by using the data source 467. The data source 467 represents all protocol layers above the L2 layer. Similar to the sending function, at the second communication device 410, described during the transmission from the second communication device 410 to the first communication device 450, the controller/processor 459 implements header compression, encryption, packet segmentation and reordering, and multiplexing between a logical channel and a transport channel based on radio resource allocation, to implement an L2 layer function for a user plane and a control plane. The controller/processor 459 is further responsible for retransmission of a lost packet, and signaling to the second communication device 410. The transmit processor 468 performs channel encoding, interleaving, and modulation mapping, and the multi-antenna transmit processor 457 performs digital multi-antenna spatial precoding, including codebook-based precoding and non-codebook-based precoding, and beam forming processing. Then the transmit processor 468 modulates a generated spatial stream into a multicarrier/single-carrier symbol stream, and the multicarrier/single-carrier symbol stream is provided for different antennas 452 by using the transmitter 454 after undergoing an analog precoding/beamforming operation in the multi-antenna transmit processor 457. Each transmitter 454 first converts a baseband symbol stream provided by the multi-antenna transmit processor 457 into a radio frequency symbol stream, and then provides the radio frequency symbol stream for the antenna 452.

During transmission from the first communication device 450 to the second communication device 410, a function at the second communication device 410 is similar to the receiving function, at the first communication device 450, described during the transmission from the second communication device 410 to the first communication device 450. Each receiver 418 receives a radio frequency signal through a corresponding antenna 420 of the receiver 418, converts the received radio frequency signal into a baseband signal, and provides the baseband signal for the multi-antenna receive processor 472 and the receive processor 470. The receive processor 470 and the multi-antenna receive processor 472 jointly implement the function of the L1 layer. The controller/processor 475 implements the function of the L2 layer. The controller/processor 475 may be associated with the memory 476 that stores program code and data. The memory 476 may be referred to as a computer-readable medium. During transmission from the first communication device 450 to the second communication device 410, the controller/processor 475 provides demultiplexing between a transport channel and a logical channel, packet reassembly, decryption, header decompression, and control signal processing, to recover an upper layer data packet from the first communication device 450. An upper layer data packet from the controller/processor 475 may be provided for a core network.

In an embodiment, the first communication device 450 includes at least one processor and at least one memory. The at least one memory includes computer program code, and the at least one memory and the computer program code are configured to be used with the at least one processor. The first communication device 450 at least: sends first type capability information and sends first information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the first communication device 450 includes a memory storing a computer-readable instruction program. The computer-readable instruction program, when executed by at least one processor, generates actions, and the actions include: sending first type capability information and sending first information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the second communication device 410 apparatus includes at least one processor and at least one memory. The at least one memory includes computer program code, and the at least one memory and the computer program code are configured to be used with the at least one processor. The second communication device 410 apparatus at least: receives first type capability information and receives first information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the second communication device 410 apparatus includes a memory storing a computer-readable instruction program. The computer-readable instruction program, when executed by at least one processor, generates actions, and the actions include: receiving first type capability information and receiving first information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In a sub-embodiment of the foregoing two embodiments, the first information may be transparent to a second node, or the second node does not parse the first information.

In a sub-embodiment of the foregoing two embodiments, the first information is distributed by the second node to a core network function on a network side, for example, through signaling such as a container.

The foregoing two sub-embodiments are applicable to NAS-related capability information reporting and have good compatibility with an existing system.

In an embodiment, the first communication device 450 corresponds to a first node in this disclosure.

In an embodiment, the second communication device 410 corresponds to a second node in this disclosure.

In an embodiment, the first communication device 450 is a UE, and the second communication device 410 is a base station.

In an embodiment, the antenna 452, the receiver 454, the multi-antenna receive processor 458, and the receive processor 456 are used for measurement on an RS resource.

In an embodiment, the controller/processor 459 is used for measurement on an RS resource.

In an embodiment, the controller/processor 459 is used to generate the first type capability information.

In an embodiment, the controller/processor 459 is used to generate the first information.

In an embodiment, the antenna 452, the transmitter 454, the multi-antenna transmit processor 457, the transmit processor 468, and the controller/processor 459 are used to send the first type capability information and the first information.

In an embodiment, the antenna 420, the transmitter 418, the multi-antenna transmit processor 471, and the transmit processor 416 are used to send reference signals on RS resources.

In an embodiment, the controller/processor 475 is used to send a reference signals on the RS resource.

In an embodiment, the antenna 420, the receiver 418, the multi-antenna receive processor 472, the receive processor 470, and the controller/processor 475 are used to receive the first type capability information.

In an embodiment, the antenna 420, the receiver 418, the multi-antenna receive processor 472, the receive processor 470, and the controller/processor 475 are used to receive the first information.

### Embodiment 5

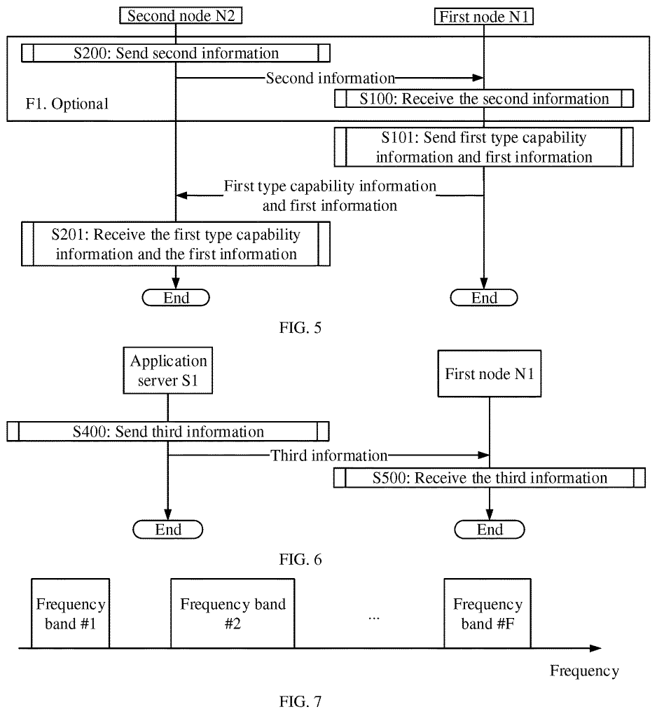

Embodiment 5 illustrates a flowchart of transmission between a first node and a second node according to an embodiment of this disclosure, as shown in FIG. 5. In FIG. 5, steps in a block F1 are optional.

For a first node N1, in step S100, second information is received, where the second information requests capability information of the first node; and in step S101, first type capability information and first information are sent.

For a second node N2, in step S200, second information is sent; and in step S201, the first type capability information and the first information are received.

In Embodiment 5, sending of the first information is triggered by receiving of the second information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the first type capability information, the second information, and the first information are all RRC layer signaling, and the first node N1 and the second node N2 are respectively a UE and a base station.

In a sub-embodiment of the foregoing embodiment, the second information and the first information are respectively a UECapabilityEnquiry message and a UECapabilityInformation message.

In an embodiment, the first type capability information is RRC layer signaling, and the second information and the first information are both non-access stratum (Non-access stratum, NAS) signaling; and the first node N1 includes a UE, and the second node N2 includes a base station and a core network function on a network side.

In a sub-embodiment of the foregoing embodiment, the second information and the first information are respectively a RequestCapabilities message and a ProvideCapabilities message.

In a sub-embodiment of the foregoing embodiment, the first node N1 includes an application server on a UE side.

In an embodiment, the application server is installed by the UE through an executable file.

In an embodiment, the application server provides an Over-the-Top (over-the-top, OTT) service.

In an embodiment, the application server is deployed outside the UE.

In an embodiment, the MIMO-related parameter of the first frequency band includes a codebook parameter. When the codebook parameter of the MIMO-related parameter of the first frequency band does not include a first type codebook, the trainable model indicated by the at least one first type identifier in the first type identifier list is unavailable for the first frequency band; and the first type codebook is non-constant modulus.

In an embodiment, the first type codebook is an enhanced second type codebook (Enhanced Type II Codebook).

In an embodiment, precision of the first type codebook is not lower than that of the enhanced second type codebook.

In an embodiment, the first type codebook includes one or more of an enhanced second type port selection codebook (Enhanced Type II Port Selection Codebook), a further enhanced second type port selection codebook (Further enhanced Type II port selection codebook), an enhanced second type codebook for CJT (Coherent Joint Transmission, coherent joint transmission) (Enhanced Type II codebook for CJT), an enhanced second type port selection codebook for CJT (Further enhanced Type II port selection codebook for CJT), an enhanced second type codebook for predicted PMI (Enhanced Type II codebook for predicted PMI), and a further enhanced second type port selection codebook for predicted PMI (Further enhanced Type II port selection codebook for predicted PMI)

In an embodiment, the MIMO-related parameter of the first frequency band includes a beam measurement-related parameter. When the beam measurement-related parameter of the MIMO-related parameter of the first frequency band does not include measuring a first type RS resource, the trainable model indicated by the at least one first type identifier in the first type identifier list is unavailable for the first frequency band.

In an embodiment, a quantity of REs per port per PRB of the first type RS resource is greater than 3.

In an embodiment, the first type RS resource is a non-zero power (NZP-)CSI-RS resource.

In an embodiment, the first type RS resource is an aperiodic non-zero power CSI-RS resource.

In an embodiment, the first type RS resource is a non-zero power CSI-RS resource for two ports.

In an embodiment, that the beam measurement-related parameter of the MIMO-related parameter of the first frequency band does not include measuring a first type RS resource refers to: the beam measurement-related parameter indicates a maximum quantity of first type RS resources for beam measurement, and the beam measurement-related parameter of the MIMO-related parameter of the first frequency band is 0.

In an embodiment, the beam measurement-related parameter is maxNumberCSI-RS-Resource.

In an embodiment, the beam measurement-related parameter is maxNumberCSI-RS-ResourceTwoTx.

In an embodiment, the first type capability information includes reporting type information. When the reporting type information on the first frequency band does not include first type reporting, the trainable model indicated by the at least one first type identifier in the first type identifier list in the first information is unavailable for the first frequency band; and the first type reporting is used to determine performance of the trainable model.

In an embodiment, the first type reporting is aperiodic.

In an embodiment, the first type reporting is aperiodic CSI.

In an embodiment, the first type reporting is an aperiodic PMI.

In an embodiment, that the reporting type information on the first frequency band does not include first type reporting refers to: the reporting type information on the first frequency band is 0, and the reporting type information on the first frequency band is a maximum quantity of first type reporting.

In an embodiment, the reporting type information is maxNumberAperiodicCSI-PerBWP-ForCSI-Report.

In an embodiment, the reporting type information is maxNumberPeriodicCSI-PerBWP-ForBeamReport.

In an embodiment, sending of the first information is triggered by any condition in a first set of conditions. One condition in the first set of conditions is that at least one first type identifier currently supported by the first node N1 does not belong to a first type identifier list reported most recently, and the first type identifier list in the first information includes the at least one first type identifier currently supported by the first node N1.

In an embodiment, one condition in the first set of conditions is receiving of the second information.

In an embodiment, that one condition in the first set of conditions is that at least one first type identifier currently supported by the first node N1 does not belong to a first type identifier list reported most recently includes: after the first type identifier list reported most recently, the application server of the first node N1 is replaced.

In an embodiment, replacing of the application server of the first node N1 includes: the first node N1 switches from a first application server to a second application server.

In an embodiment, both the first application server and the second application server are deployed on the first node N1.

In an embodiment, the first application server and the second application server are two different applications.

In an embodiment, the first application server and the second application server are two different executable files.

In an embodiment, both the first application server and the second application server are deployed on a remote server other than the first node N1; and switching from the first application server to the second application server is triggered by moving of the first node N1, or triggered by the first node N1 executing a new application.

In an embodiment, that one condition in the first set of conditions is that at least one first type identifier currently supported by the first node N1 does not belong to a first type identifier list reported most recently includes: after the first type identifier list reported most recently, the first node N1 receives signaling from the application server, and the signaling from the application server indicates the first type identifier currently supported by the first node N1.

Similarly, the application server in the foregoing embodiment is deployed in the first node N1, or deployed on a remote server other than the first node N1.

In an embodiment, the signaling from the application server is NAS signaling.

In an embodiment, the signaling from the application server is application layer signaling, which is outside the scope of 3GPP.

### Embodiment 6

Embodiment 6 illustrates a schematic diagram of transmission of third information according to an embodiment of this disclosure, as shown in FIG. 6.

For an application server S1, third information is sent in step S400. For a first node N1, the third information is received in step S500.

In Embodiment 6, the third information indicates a plurality of first type identifiers currently supported by the first node N1, receiving of the third information is used to trigger sending of the first information, at least one first type identifier in the plurality of first type identifiers does not belong to a first type identifier list reported most recently by the first node N1 to a second node N2, and the first type identifier list in the first information includes the plurality of first type identifiers.

In an embodiment, the application server is an application installed on the first node N1, and the third information is transmitted within the first node N1.

In an embodiment, the application server is a remote server other than the first node N1, and a transmission path of the third information includes an air interface.

### Embodiment 7

Embodiment 7 illustrates a schematic diagram of a plurality of frequency bands according to an embodiment of this disclosure, as shown in FIG. 7. In FIG. 7, a frequency band #1, a frequency band #2, . . . , and a frequency band #F are F frequency bands indicated by first type capability information.

In an embodiment, first type capability information includes sub-capability information, the plurality of pieces of sub-capability information respectively indicates the F frequency bands, where the first frequency band is any one of the F frequency bands.

In an embodiment, the F frequency bands are respectively F NR frequency bands (frequency band).

In an embodiment, the sub-capability information is a BandNR IE.

In an embodiment, the sub-capability information includes part or all of fields in BandNR, and the frequency band is indicated by FreqBandIndicatorNR in corresponding sub-capability information.

In an embodiment, the first type capability information is a supportedBandListNR IE, and first information is RRC signaling and the first information does not belong to the supportedBandListNR IE.

In a sub-embodiment of the foregoing embodiment, the first type capability information and the first information belong to an RF-Parameters IE.

In a sub-embodiment of the foregoing embodiment, the first type capability information and the first information belong to a UECapabilityInformation IE.

In a sub-embodiment of the foregoing embodiment, the first type capability information and the first information respectively belong to an RF-Parameters IE in a UECapabilityInformation IE and a Phy-Parameters IE in the UECapabilityInformation IE.

The foregoing several embodiments maintain good compatibility, and avoid configuring the first information for each frequency band, to save signaling overheads.

### Embodiment 8

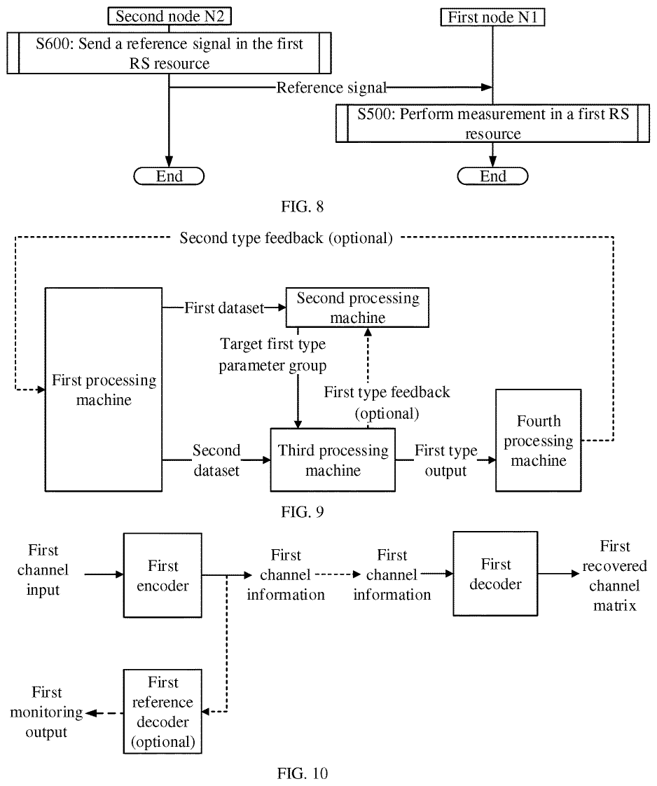

Embodiment 8 illustrates a flowchart of measurement in a first RS resource according to an embodiment of this disclosure, as shown in FIG. 8.

A first node N1 performs measurement in the first RS resource in step S500; and a second node N2 sends a reference signal in the first RS resource.

By way of using the measurement in the first RS resource, the trainable model in this disclosure can be used to generate inference information. Combined with Embodiment 5, the first node N1 reports the inference information to the second node N2. A type of the inference information varies with an application scenario. A typical implementation is disclosed below in combination with CSI feedback. However, a person skilled in the art should know that the method and the apparatus of this disclosure are applicable to another implementation or inference information other than the CSI feedback, such as beam prediction and positioning information.

The first node N1 measures a reference signal in at least first RS resource to obtain a raw channel matrix or a precoding matrix, and uses a first encoder to generate first channel information based on the obtained raw channel matrix or the precoding matrix. The first node N1 feeds back the first channel information to the second node N2, and the second node N2 inputs the first channel information to a first decoder to obtain a recovered channel parameter. The first decoder may be considered as an inverse operation of the first encoder, and both the first encoder and the first decoder are obtained through training, for example, they belong to trainable models.

In an embodiment, the first channel information indicates the precoding matrix.

In an embodiment, the recovered channel parameter is the precoding matrix.

In an embodiment, the precoding matrix is of spatial-frequency domain.

In an embodiment, the precoding matrix is of angular-delay domain projection.

In an embodiment, the first channel information indicates the raw channel matrix.

In an embodiment, the recovered channel parameter is the raw channel matrix.

In an embodiment, the raw channel matrix is of spatial-frequency domain.

In an embodiment, the raw channel matrix is of angular-delay domain.

In an embodiment, the first channel information is used to determine a phase, or an amplitude, or a coefficient between at least two antenna ports.

In an embodiment, the first channel information is used to determine at least one eigenvector.

In an embodiment, the first channel information is used to determine at least one eigenvalue.

A valid codebook may be used to monitor or calibrate performance of the first encoder and/or the first decoder; for example, the first node N1 periodically or aperiodically reports a PMI to the second node N2. Generally, how to select a precoding matrix from the valid codebook is implementation-related, for example, left to each manufacturer to determine; and common schemes include maximizing spatial projection, or maximizing a channel capacity, and the like. The following describes a typical but non-limiting embodiment.

The first node N1 first measures a downlink RS (for example, the first RS resource) to obtain the raw channel matrix (or the precoding matrix indicated by the first channel information) H_{r×t} where r,t are respectively a quantity of receive antennas and a quantity of antenna ports used for sending. Under a condition of using the precoding matrix W_{t×l}, the encoded channel parameter matrix is H_{r×t}·W_{t×l}, where l is a quantity of ranks (rank) or layers, and an equivalent channel capacity of H_{r×t}·W_{t×l} is calculated using criteria such as a signal-to-interference-plus-noise ratio (SINR), Exponential Effective SINR Mapping, exponential effective SINR mapping (EESM), or a received block mean mutual information ratio (RBIR). Further, the calculation of the equivalent channel capacity may also consider noise and interference estimated by the first node N1. If the downlink RS includes RS resources for interference measurement, the first node N1 may use these RS resources to more accurately measure interference or noise. The first node N1 selects a precoding matrix corresponding to a maximum equivalent channel capacity from the valid codebook as a virtual precoding matrix.

To improve precision of monitoring or calibration, the valid codebook is the first type codebook of this disclosure.

It should be additionally noted that when the first node N1 and the second node N2 use different channel reconstruction models, understanding of the first node N1 and the second node N2 for the precoding matrix indicated by the first channel information may not be the same.

Typically, the first channel information is generated based on an artificial intelligence method.

In an embodiment, the first channel information is transmitted on a first physical layer channel.

In an embodiment, the first physical layer channel is a Physical Uplink Shared Channel (PUSCH).

In an embodiment, the first physical layer channel is a PUCCH.

### Embodiment 9

Embodiment 9 illustrates a schematic diagram of a system including a trainable model according to an embodiment of this disclosure, as shown in FIG. 9. FIG. 9 includes a first processing machine, a second processing machine, a third processing machine, and a fourth processing machine.

In Embodiment 9, the first processing machine sends a first dataset to the second processing machine, the second processing machine generates a target first type parameter group based on the first dataset, the second processing machine sends the generated target first type parameter group to the third processing machine, the third processing machine processes a second dataset using the target first type parameter group to obtain a first type output, and then sends the first type output to the fourth processing machine.

In an embodiment, the third processing machine sends first type feedback to the second processing machine, and the first type feedback is used to trigger recalculation or update of the target first type parameter group.

In an embodiment, the fourth processing machine sends second type feedback to the first processing machine, and the second type feedback is used to generate the first dataset or the second dataset, or the second type feedback is used to trigger sending of the first dataset or the second dataset.

In an embodiment, the first processing machine generates the first dataset and the second dataset based on measurement of a first wireless signal, and the first wireless signal includes a downlink RS.

In an embodiment, the second dataset is obtained based on measurement in a first RS resource.

In an embodiment, the first processing machine and the third processing machine belong to a first node, and the fourth processing machine belongs to a second node.

In an embodiment, the first type output includes at least first channel information.

In an embodiment, the first type output includes reporting of a plurality of non-codebooks, and the first channel information is one piece of reporting of the plurality of non-codebooks.

In an embodiment, the second processing machine belongs to the first node.

In an embodiment, the trainable model includes the third processing machine.

In an embodiment, the trainable model includes the second processing machine and the third processing machine.

In an embodiment, the trainable model includes the fourth processing machine and the third processing machine.

The foregoing embodiment avoids transmitting the first dataset to the second node.

In an embodiment, the second processing machine belongs to the second node.

The foregoing embodiment reduces complexity of the first node.

In an embodiment, the first dataset is training data, the second dataset is interference data, the second processing machine is used to train a model, and the trained model is described by the target first type parameter group.

In an embodiment, the third processing machine constructs a model based on the target first type parameter group, then inputs the second dataset into the constructed model to obtain the first type output, and then sends the first type output to the fourth processing machine.

In a sub-embodiment of the foregoing embodiment, the third processing machine includes a first encoder of this disclosure, the first encoder is described by the target first type parameter group, and generation of the first type output is performed by the first encoder.

In an embodiment, the third processing machine calculates an error between the first type output and actual data to determine performance of the trained model, and the actual data is data received after the second dataset and transmitted by the first processing machine.

The foregoing embodiment is particularly suitable for prediction-related reporting.

In an embodiment, the third processing machine recovers a reference dataset based on the first type output, and an error between the reference dataset and the second dataset is used to generate the first type feedback.

The recovery of the reference dataset usually adopts an inverse operation similar to the target first type parameter group, and the foregoing embodiment is particularly suitable for CSI compression-related reporting.

In an embodiment, the first type feedback is used to reflect the performance of the trained model; and when the performance of the trained model cannot meet a requirement, the second processing machine recalculates the target first type parameter group.

In a sub-embodiment of the foregoing embodiment, the third processing machine includes a first reference decoder of this disclosure, and the first reference decoder is described by the target first type parameter group. An input of the first reference decoder includes the first type output, and the output of the first reference decoder includes the reference dataset.

Typically, when the error is quite large or updated is not performed for a long time, the performance of the trained model is considered to not meet the requirement.

In an embodiment, the third processing machine belongs to the second node, and the first node reports the target first type parameter group to the second node.

### Embodiment 10

Embodiment 10 illustrates a flowchart of transmission of first channel information according to an embodiment of this disclosure, as shown in FIG. 10. In FIG. 10, a first reference decoder is optional.

In Embodiment 10, a first encoder and a first decoder respectively belong to a first node and a second node, the first encoder belongs to a first transmitter, and the first decoder belongs to a second receiver.

The first transmitter generates at least first channel information using the first encoder, an input of the first encoder includes a first channel input, the first encoder is obtained through training, and the first channel input is obtained based on measurement for a first RS resource group.

The first node feeds back the first channel information to the second node through an air interface.

The second receiver generates a first recovered channel matrix using the first decoder, an input of the first decoder includes the first channel information, and the first decoder is obtained through training.

The first encoder and the first decoder should theoretically be inverse operations to ensure that the first channel input is the same as the first recovered channel matrix.

In an embodiment, due to factors such as implementation complexity, air interface overheads, or a delay, the first encoder and the first decoder in Embodiment 10 cannot ensure complete cancellation, so the first channel input and the first recovered channel matrix cannot be ensured to be exactly the same. This leads to different understanding of a precoding matrix represented by the first channel information by both parties.

In an embodiment, the first channel input is a raw channel matrix.

In an embodiment, the first channel input is a precoding matrix.

In an embodiment, the first transmitter further includes a first reference decoder, an input of the first reference decoder includes the first channel information, and an output of the first reference decoder includes a first monitoring output.

In an embodiment, the first channel matrix is the first monitoring output, and the first reference decoder and the first decoder cannot be considered the same.

In the foregoing embodiment, the first reference decoder and the first decoder may be independently generated or independently maintained. Therefore, although both aim to perform an inverse operation of the first encoder, the first reference decoder and the first decoder may only be approximate to each other.

In an embodiment, the first transmitter includes the third processing machine in Embodiment 9.

In an embodiment, the first channel input belongs to the second dataset in Embodiment 9.

In an embodiment, the training of the first encoder is performed at the first node.

In an embodiment, the training of the first encoder is performed by the second node.

In an embodiment, the first recovered channel matrix is known only to the second node.

In an embodiment, the first recovered channel matrix and the first channel matrix cannot be considered the same.

In an embodiment, the trainable model includes the first encoder.

In an embodiment, the trainable model includes the first encoder and the first decoder.

### Embodiment 11

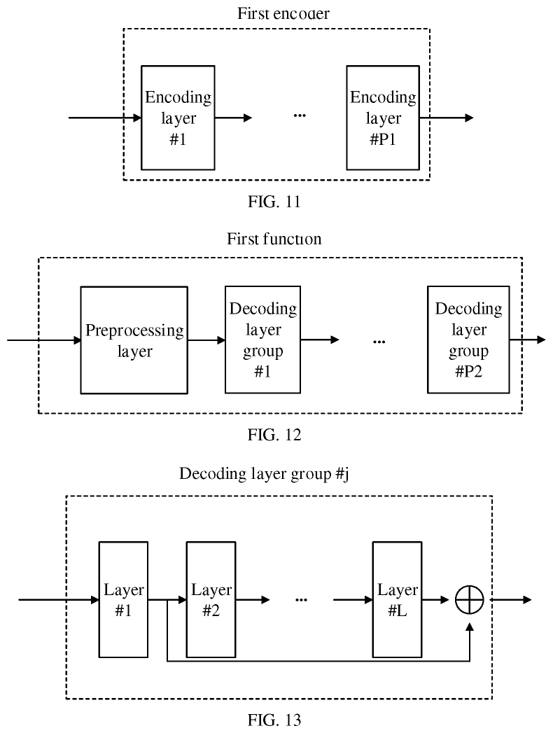

Embodiment 11 illustrates a schematic diagram of a first encoder according to an embodiment of this disclosure, as shown in FIG. 11. In FIG. 11, the first encoder includes P1 encoding layers, namely encoding layers #1, #2, . . . , and #P1.

In an embodiment, P1 is 2, for example, the P1 encoding layers include an encoding layer #1 and an encoding layer #2. The encoding layer #1 and the encoding layer #2 are respectively a convolutional layer and a fully connected layer. At the convolutional layer, at least one convolution kernel is used to convolve a first channel input to generate a corresponding feature map, and at least one feature map output by the convolutional layer is reshaped (reshape) into a vector and input to the fully connected layer. The fully connected layer converts the vector into first channel information. For more detailed descriptions, refer to CNN-related technical literatures, such as Chao-Kai Wen, Deep Learning for Massive MIMO CSI Feedback, IEEE WIRELESS COMMUNICATIONS LETTERS, VOL. 7, NO. 5, OCTOBER 2018.

In an embodiment, P1 is 3, for example, the P1 encoding layers include a fully connected layer, a convolutional layer, and a pooling layer.

### Embodiment 12

Embodiment 12 illustrates a schematic diagram of a first function according to an embodiment of this disclosure, as shown in FIG. 12. In FIG. 12, the first function includes a preprocessing layer and P2 decoding layer groups, namely decoding layer groups #1, #2, . . . , and #P2, where each decoding layer group includes at least one decoding layer.

A structure of the first function is applicable to the first decoder and the first reference decoder in Embodiment 10.

In an embodiment, the preprocessing layer is a fully connected layer that expands a size of first channel information to a size of a first channel input.

In an embodiment, structures of any two decoding layer groups in the P2 decoding layer groups are the same, and the structure includes a quantity of included decoding layers, a size of an input parameter and a size of an output parameter of each included decoding layer, and the like.

In an embodiment, a second node indicates P2 and the structure of the decoding layer group to a first node, and the first node indicates another parameter of the first function through second signaling.

In an embodiment, the another parameter includes at least one of a threshold of an activation function, a size of a convolution kernel, a step size of a convolution kernel, and weights between feature maps.

### Embodiment 13

Embodiment 13 illustrates a schematic diagram of a decoding layer group according to an embodiment of this disclosure, as shown in FIG. 13. In FIG. 13, the decoding layer group #j includes L layers, namely layers #1, #2, . . . , and #L, and the decoding layer group is any one of P2 decoding layer groups.

In an embodiment, L is 4, a first layer in the L layers is an input layer, and the remaining three layers in the L layers are convolutional layers. More detailed descriptions can refer to CNN-related technical literatures, such as Chao-Kai Wen, Deep Learning for Massive MIMO CSI Feedback, IEEE WIRELESS COMMUNICATIONS LETTERS, VOL. 7, NO. 5, OCTOBER 2018, and the like.

In an embodiment, the L layers include at least one convolutional layer and one pooling layer.

### Embodiment 14

Embodiment 14 illustrates a block diagram of a structure of a processing apparatus in a first node according to an embodiment of this disclosure, as shown in FIG. 14. In FIG. 14, the processing apparatus 1600 in the first node includes a first receiver 1601 and a first transmitter 1602, and the first receiver 1601 is optional.

The first receiver 1601 receives second information, where the second information requests capability information of the first node, and the first transmitter 1602 sends first type capability information and first information.

In Embodiment 14, sending of the first information is triggered by receiving of the second information. The first type capability information includes a MIMO-related parameter of a first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the MIMO-related parameter of the first frequency band includes a codebook parameter. When the codebook parameter of the MIMO-related parameter of the first frequency band does not include a first type codebook, the trainable model indicated by the at least one first type identifier in the first type identifier list is unavailable for the first frequency band; and the first type codebook is non-constant modulus.

In an embodiment, the MIMO-related parameter of the first frequency band includes a beam measurement-related parameter. When the beam measurement-related parameter of the MIMO-related parameter of the first frequency band does not include measuring a first type RS resource, the trainable model indicated by the at least one first type identifier in the first type identifier list is unavailable for the first frequency band.

In an embodiment, the first type capability information includes reporting type information. When the reporting type information on the first frequency band does not include first type reporting, the trainable model indicated by the at least one first type identifier in the first type identifier list in the first information is unavailable for the first frequency band; and the first type reporting is used to determine performance of the trainable model.

In an embodiment, sending of the first information is triggered by any condition in a first set of conditions.

One condition in the first set of conditions is that at least one first type identifier currently supported by the first node does not belong to a first type identifier list reported most recently, and the first type identifier list in the first information includes the at least one first type identifier currently supported by the first node.

In an embodiment, that one condition in the first set of conditions is that at least one first type identifier currently supported by the first node does not belong to a first type identifier list reported most recently includes at least one of the following: after the first type identifier list reported most recently, an application server of the first node is replaced; and after the first type identifier list reported most recently, the first node receives signaling from the application server, and the signaling from the application server indicates the first type identifier currently supported by the first node.

In an embodiment, the first node is a user equipment.

In an embodiment, the first transmitter 1602 includes at least one of the antenna 452, the transmitter/receiver 454, the multi-antenna transmitter processor 457, the transmit processor 468, the controller/processor 459, the memory 460, and the data source 467 in FIG. 4 of this disclosure.

In an embodiment, the first transmitter 1602 includes the antenna 452, the transmitter/receiver 454, the multi-antenna transmitter processor 457, the transmit processor 468, the controller/processor 459, the memory 460, and the data source 467 in FIG. 4 of this disclosure.

In an embodiment, the first receiver 1601 includes at least first five of the antenna 452, the receiver 454, the multi-antenna receive processor 458, the receive processor 456, the controller/processor 459, the memory 460, and the data source 467 in FIG. 4 of this disclosure.

In an embodiment, the first receiver 1601 includes at least first four of the antenna 452, the receiver 454, the multi-antenna receive processor 458, the receive processor 456, the controller/processor 459, the memory 460, and the data source 467 in FIG. 4 of this disclosure.

In an embodiment, the first receiver 1601 includes at least first three of the antenna 452, the receiver 454, the multi-antenna receive processor 458, the receive processor 456, the controller/processor 459, the memory 460, and the data source 467 in FIG. 4 of this disclosure.

### Embodiment 15

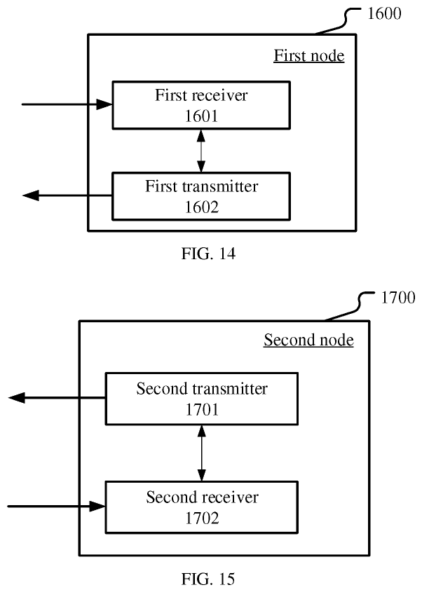

Embodiment 15 illustrates a block diagram of structure of a processing apparatus in a second node according to an embodiment of this disclosure, as shown in FIG. 15. In FIG. 15, the processing apparatus 1700 in the second node includes a second transmitter 1701 and a second receiver 1702, and the second transmitter 1701 is optional.

The second transmitter 1701 sends second information, where the second information requests capability information of a first node, and the second receiver 1702 receives first type capability information and first information.

In Embodiment 15, sending of the first information is triggered by receiving of the second information, the first type capability information includes a MIMO-related parameter of the first frequency band, the first information includes a first type identifier list, and any first type identifier in the first type identifier list indicates a trainable model. For the trainable model indicated by at least one first type identifier in the first type identifier list in the first information, whether the trainable model is applied to the first frequency band depends on the MIMO-related parameter on the first frequency band.

In an embodiment, the first information is sent after the first type capability information.

In an embodiment, the MIMO-related parameter of the first frequency band includes a codebook parameter. When the codebook parameter of the MIMO-related parameter of the first frequency band does not include a first type codebook, the trainable model indicated by the at least one first type identifier in the first type identifier list is unavailable for the first frequency band; and the first type codebook is non-constant modulus.

In an embodiment, the MIMO-related parameter of the first frequency band includes a beam measurement-related parameter. When the beam measurement-related parameter of the MIMO-related parameter of the first frequency band does not include measuring a first type RS resource, the trainable model indicated by the at least one first type identifier in the first type identifier list is unavailable for the first frequency band.

In an embodiment, the first type capability information includes reporting type information. When the reporting type information on the first frequency band does not include first type reporting, the trainable model indicated by the at least one first type identifier in the first type identifier list in the first information is unavailable for the first frequency band; and the first type reporting is used to determine performance of the trainable model.

In an embodiment, sending of the first information is triggered by any condition in a first set of conditions. One condition in the first set of conditions is that at least one first type identifier currently supported by the first node does not belong to a first type identifier list reported most recently, and the first type identifier list in the first information includes the at least one first type identifier currently supported by the first node.

In an embodiment, that one condition in the first set of conditions is that at least one first type identifier currently supported by the first node does not belong to a first type identifier list reported most recently includes at least one of the following: after the first type identifier list reported most recently, an application server of the first node is replaced; and after the first type identifier list reported most recently, the first node receives signaling from the application server, and the signaling from the application server indicates the first type identifier currently supported by the first node.

In an embodiment, the second node is a base station device.

In an embodiment, the second node 1700 includes a base station device and a core network function.

In an embodiment, the second transmitter 1701 includes the antenna 420, the transmitter 418, the transmit processor 416, and the controller/processor 475.

In an embodiment, the second transmitter 1701 includes the antenna 420, the transmitter 418, the multi-antenna transmit processor 471, the transmit processor 416, and the controller/processor 475.

In an embodiment, the second transmitter 1701 includes the antenna 420, the transmitter 418, the transmit processor 416, and the controller/processor 475.

In an embodiment, the second transmitter 1701 includes the antenna 420, the transmitter 418, the multi-antenna transmit processor 471, the transmit processor 416, and the controller/processor 475.

In an embodiment, the second receiver 1702 includes the antenna 420, the receiver 418, the multi-antenna receive processor 472, the receive processor 470, and the controller/processor 475.

In an embodiment, the second receiver 1702 includes the controller/processor 475.

A person of ordinary skill in the art may understand that all or part of the steps of the foregoing methods may be implemented by a program instructing relevant hardware. The program may be stored in a computer-readable storage medium, such as a read-only memory, a hard disk, or an optical disk. Optionally, all or part of the steps of the foregoing embodiments may also be implemented using one or more integrated circuits. Correspondingly, each module unit in the foregoing embodiments may be implemented in a form of hardware, or may be implemented in a form of a software functional module. This disclosure is not limited to any specific combination of software and hardware. The user equipment, the terminal, and the UE in this disclosure include, but are not limited to, drones, communication modules on drones, remote control aircrafts, flying machines, small aircrafts, mobile phones, tablet computers, notebook computers, vehicle-mounted communication devices, wireless sensors, network cards, internet of things terminals, RFID terminals, NB-IOT terminals, Machine Type Communication (MTC) terminals, enhanced MTC (eMTC) terminals, data cards, low-cost mobile phones, low-cost tablet computers, and other wireless communication devices. The base station or system device in this disclosure includes, but is not limited to, a macro cellular base station, a micro cellular base station, a home base station, a relay base station, a gNB (NR NodeB) NR NodeB, a transmission reception point (TRP), and another wireless communication device.

A person skilled in the art should understand that this disclosure may be implemented in other specific forms without departing from core or essential characteristics thereof. Therefore, the currently disclosed embodiments should in no way be regarded as restrictive, but rather as illustrative. The scope of the present disclosure is defined by the appended claims rather than by the foregoing description, and all modifications falling within the equivalent meaning and range thereof are considered to be included therein.

What is claimed is:

1. A first node used for wireless communication, comprising:
a first transmitter configured to:
send first type capability information comprising a multiple-input multiple-output (MIMO)-related parameter of a first frequency band; and
send first information comprising a first type identifier list, wherein each first type identifier in the first type identifier list indicates a trainable model, and wherein whether the trainable model indicated by at least one first type identifier in the first type identifier list is appliable to the first frequency band is determinable based on the MIMO-related parameter on the first frequency band.

2. The first node of claim 1, wherein the MIMO-related parameter of the first frequency band comprises a codebook parameter, wherein when the codebook parameter of the MIMO-related parameter of the first frequency band does not comprise a first type codebook, the trainable model indicated by the at least one first type identifier in the first type identifier list is unavailable for the first frequency band, and wherein the first type codebook is non-constant modulus.

3. The first node of claim 1, wherein the MIMO-related parameter of the first frequency band comprises a beam measurement-related parameter, and wherein when the beam measurement-related parameter of the MIMO-related parameter of the first frequency band does not comprise measuring a first type RS resource, the trainable model indicated by the at least one first type identifier in the first type identifier list is unavailable for the first frequency band.

4. The first node of claim 1, wherein the first type capability information comprises reporting type information, wherein when the reporting type information on the first frequency band does not comprise first type reporting, the trainable model indicated by the at least one first type identifier in the first type identifier list in the first information is unavailable for the first frequency band, and wherein the first type reporting is used to determine performance of the trainable model.

5. The first node of claim 1, wherein sending of the first information is triggered by any condition in a first set of conditions, wherein one condition in the first set of conditions is that at least one first type identifier currently supported by the first node does not belong to a first type identifier list reported most recently, and wherein the first type identifier list in the first information comprises the at least one first type identifier currently supported by the first node.

6. The first node of claim 1, comprising a first receiver configured to receive second information, wherein the second information requests capability information of the first node, and wherein sending of the first information is triggered by receiving of the second information.

7. The first node of claim 5, wherein that one condition in the first set of conditions is that at least one first type identifier currently supported by the first node does not belong to a first type identifier list reported most recently comprises at least one of, after the first type identifier list is reported:
an application server of the first node is replaced; or
the first node receives signaling from the application server indicating the first type identifier currently supported by the first node.

8. A method in a first node used for wireless communication, comprising:
sending first type capability information comprising a multiple-input multiple-output (MIMO)-related parameter of a first frequency band; and
sending first information comprising a first type identifier list, wherein each first type identifier in the first type identifier list indicates a trainable model, and wherein whether the trainable model indicated by at least one first type identifier in the first type identifier list is appliable to the first frequency band is determinable based on the MIMO-related parameter on the first frequency band.

9. The method of claim 8, wherein the MIMO-related parameter of the first frequency band comprises a codebook parameter, wherein when the codebook parameter of the MIMO-related parameter of the first frequency band does not comprise a first type codebook, the trainable model indicated by the at least one first type identifier in the first type identifier list is unavailable for the first frequency band, and wherein the first type codebook is non-constant modulus.

10. The method of claim 8, wherein the MIMO-related parameter of the first frequency band comprises a beam measurement-related parameter, and wherein when the beam measurement-related parameter of the MIMO-related parameter of the first frequency band does not comprise measuring a first type RS resource, the trainable model indicated by the at least one first type identifier in the first type identifier list is unavailable for the first frequency band.

11. The method of claim 8, wherein the first type capability information comprises reporting type information, wherein when the reporting type information on the first frequency band does not comprise first type reporting, the trainable model indicated by the at least one first type identifier in the first type identifier list in the first information is unavailable for the first frequency band, and wherein the first type reporting is used to determine performance of the trainable model.

12. The method of claim 8, wherein sending of the first information is triggered by any condition in a first set of conditions, wherein one condition in the first set of conditions is that at least one first type identifier currently supported by the first node does not belong to a first type identifier list reported most recently, and wherein the first type identifier list in the first information comprises the at least one first type identifier currently supported by the first node.

13. The method of claim 8, further comprising receiving second information, wherein the second information requests capability information of the first node, and wherein sending of the first information is triggered by receiving of the second information.

14. The method of claim 12, wherein that one condition in the first set of conditions is that at least one first type identifier currently supported by the first node does not belong to a first type identifier list reported most recently comprises at least one of, after the first type identifier list is reported:
an application server of the first node is replaced; or
the first node receives signaling from the application server indicating the first type identifier currently supported by the first node.

15. A method in a second node used for wireless communication, comprising:
receiving first type capability information comprising a multiple-input multiple-output (MIMO)-related parameter of a first frequency band; and
receiving first information comprising a first type identifier list, wherein each first type identifier in the first type identifier list indicates a trainable model, and wherein whether the trainable model indicated by at least one first type identifier in the first type identifier list is appliable to the first frequency band is determinable based on the MIMO-related parameter on the first frequency band.

16. The method of claim 15, wherein the MIMO-related parameter of the first frequency band comprises a codebook parameter, wherein the codebook parameter of the MIMO-related parameter of the first frequency band does not comprise a first type codebook, the trainable model indicated by the at least one first type identifier in the first type identifier list is unavailable for the first frequency band, and wherein the first type codebook is non-constant modulus.

17. The method of claim 15, wherein the MIMO-related parameter of the first frequency band comprises a beam measurement-related parameter, and wherein when the beam measurement-related parameter of the MIMO-related parameter of the first frequency band does not comprise measuring a first type RS resource, the trainable model indicated by the at least one first type identifier in the first type identifier list is unavailable for the first frequency band.

18. The method of claim 15, wherein the first type capability information comprises reporting type information, wherein when the reporting type information on the first frequency band does not comprise first type reporting, the trainable model indicated by the at least one first type identifier in the first type identifier list in the first information is unavailable for the first frequency band, and wherein the first type reporting is used to determine performance of the trainable model.

19. The method of claim 15, wherein sending of the first information is triggered by any condition in a first set of conditions, wherein one condition in the first set of conditions is that at least one first type identifier currently supported by the first node does not belong to a first type identifier list reported most recently, and wherein the first type identifier list in the first information comprises the at least one first type identifier currently supported by the first node.

20. The method of claim 15, further comprising sending second information, wherein the second information requests capability information of the first node, and wherein sending of the first information is triggered by receiving of the second information.
